(19) United States
(12) Patent Application Publication
(10) Pub. No.: US 2013/0254463 A1
(43) Pub. Date: Sep. 26, 2013

(54) MEMORY SYSTEM

(71) Applicant: KABUSHIKI KAISHA TOSHIBA, Tokyo (JP)

(72) Inventors: Naoki MATSUNAGA, Tokyo (JP); Atsushi IIDUKA, Kanagawa (JP)

(73) Assignee: Kabushiki Kaisha Toshiba, Tokyo (JP)

(21) Appl. No.: 13/768,344

(22) Filed: Feb. 15, 2013

(30) Foreign Application Priority Data
Mar. 23, 2012 (JP) 2012-066734
Mar. 23, 2012 (JP) 2012-066736

(51) Int. Cl. G06F 12/02

(52) U.S. Cl. CPC G06F 12/0246
USPC 711/103

(57) ABSTRACT

According to an embodiment, a memory system includes a nonvolatile memory that stores system data into a first address, a first data verifying unit, an address selecting unit, a first data operating unit, a second data verifying unit and a second data operating unit.

The first data verifying unit reads the system data from the first address and verifies the system data read from the first address.

The address selecting unit selects a second address when a verification result is not good.

The first data operating unit that copies the system data stored in the first address into the second address.

The second data verifying unit that reads the system data copied into the second address and verifies the system data read from the second address.

The second data operating unit that erases the system data stored in the first address when a verification result is good.

### CROSS-REFERENCE TO RELATED APPLICATIONS

This application is based upon and claims the benefit of priority from Japanese Patent Application No. 2012-066734, filed on Mar. 23, 2012 and Japanese Patent Application No. 2012-066736, filed on Mar. 23, 2012; the entire contents of all of which are incorporated herein by reference.

### FIELD

The embodiments discussed herein generally relate to a memory system.

### BACKGROUND

Solid state drives (SSDs) on which a memory chip that includes NAND-type storage cells is mounted have attracted attention as a memory system used in a computer system. SSDs have advantages in terms of their higher speed and lower weight as compared to magnetic disk drives.

### BRIEF DESCRIPTION OF THE DRAWINGS

FIG. 1 is a view illustrating a configuration example of an SSD according to a first embodiment;

FIG. 2 is a circuit diagram illustrating a configuration example of one block included in a memory cell array;

FIG. 3 is a view illustrating an example of a threshold distribution;

FIG. 4 is a view for describing data stored by a memory cell array;

FIG. 5 is a view for describing a functional configuration for executing a reliability guaranteeing process;

FIG. 6 is a flowchart for describing a reliability guaranteeing process of the SSD according to the first embodiment;

FIG. 7 is a flowchart for describing a reliability guaranteeing process of an SSD according to a second embodiment;

FIG. 8 is a view for describing a memory configuration of a NAND memory;

FIG. 9 is a view for describing a functional configuration of an SSD according to a fourth embodiment;

FIG. 10 is a flowchart for describing a power-on operation of the SSD according to the fourth embodiment;

FIG. 11 is a flowchart for describing a power-off operation of the SSD according to the fourth embodiment;

FIG. 12 is a flowchart for describing a management table multiplexing process according to the fourth embodiment;

FIG. 13 is a flowchart for describing a management table multiplexing process according to a fifth embodiment;

FIG. 14 is a view for describing a configuration example of a management table storage area;

FIG. 15 is a view for describing a configuration example of a backup table storage area according to the fifth embodiment;

FIG. 16 is a flowchart for describing a management table multiplexing process according to a sixth embodiment;

FIG. 17 is a view for describing a configuration example of a backup table storage area according to the sixth embodiment;

FIG. 18 is a view for describing a configuration example of a backup table storage area according to a seventh embodiment;

FIG. 19 is a flowchart for describing a management table multiplexing process according to the seventh embodiment; and

FIG. 20 is a flowchart for describing a power-on operation of an SSD according to the seventh embodiment.

### DETAILED DESCRIPTION

According to an embodiment, a memory system includes a nonvolatile memory, a first data verifying unit, an address selecting unit, a first data operating unit, a second data verifying unit and a second data operating unit. The nonvolatile memory stores system data into a first address. The first data verifying unit reads the system data from the first address at a predetermined point in time and verifies the system data read from the first address. The address selecting unit selects a second address of the nonvolatile memory different from the first address when a verification result obtained by the first data verifying unit is not good. The first data operating unit copies the system data stored in the first address into the second address. The second data verifying unit reads the system data copied into the second address and verifies the system data read from the second address. The second data operating unit erases the system data stored in the first address when a verification result obtained by the second data verifying unit is good.

Hereinafter, a memory system according to embodiments will be described in detail with reference to the accompanying drawings. The present invention is not limited to these embodiments. Hereinafter, although a case where a memory system according to an embodiment is applied to an SSD is described, a range of application fields of the memory system according to the embodiment is not limited to the SSD only.

### First Embodiment

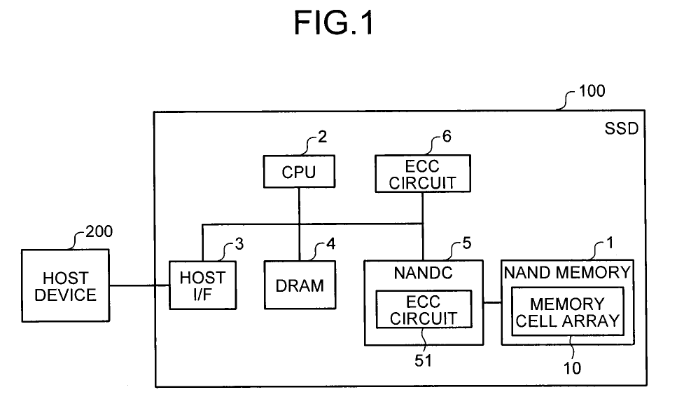

FIG. 1 is a view illustrating a configuration example of an SSD according to a first embodiment. As illustrated in the figure, an SSD 100 is connected to a host device 200 such as a personal computer via a predetermined communication interface and functions as an external storage device of the host device 200. A read request and a write request that the SSD 100 receives from the host device 200 include a header address of an access target area that is defined according to logical block addressing (LBA) and a sector size that indicates a range of access target areas. The communication interface is not limited to the SATA standard, and various communication interface standards such as serial attached SCSI (SAS) or PCI express (PCIe) can be employed.

The SSD 100 includes a NAND memory 1, a central processing unit (CPU) 2, a host interface (host I/F) 3, a dynamic random access memory (DRAM) 4, a NAND controller (NANDC) 5, and an error checking and correcting (ECC) circuit 6. The CPU 2, the host I/F 3, the DRAM 4, the NANDC 5, and the ECC circuit 6 are connected to each other by a bus. Moreover, the NAND memory 1 is connected to the NANDC 5.

The DRAM 4 is a volatile memory that temporarily stores data transmitted between the host device 200 and the NAND memory 1. The host I/F 3 controls a communication interface between the SSD 100 and the host device 200 and executes transmission of data between the host device 200 and the DRAM 4. The CPU 2 executes control of the entire SSD 100 based on a firmware (firmware program) 111.

The NANDC 5 executes transmission of data between the NAND memory 1 and the DRAM 4. Moreover, the NANDC 5 includes an ECC circuit 51 that corrects an error that occurs when the NAND memory 1 is accessed. The ECC circuit 51 encodes a second error correction code (ECC) and encodes and decodes a first error correction code (ECC).

The ECC circuit 6 decodes the second error correction code (ECC). The first and second error correction codes (ECCs) are Hamming codes, Bose Chaudhuri Hocqenghem (BCH) codes, Reed Solomon (RS) codes, or low density parity check (LDPC) codes, for example. It is assumed that the correction ability of the second error correction code (ECC) is higher than the correction ability of the first error correction code (ECC).

The NAND memory 1 includes a memory cell array 10 that stores the writing data from the host device 200.

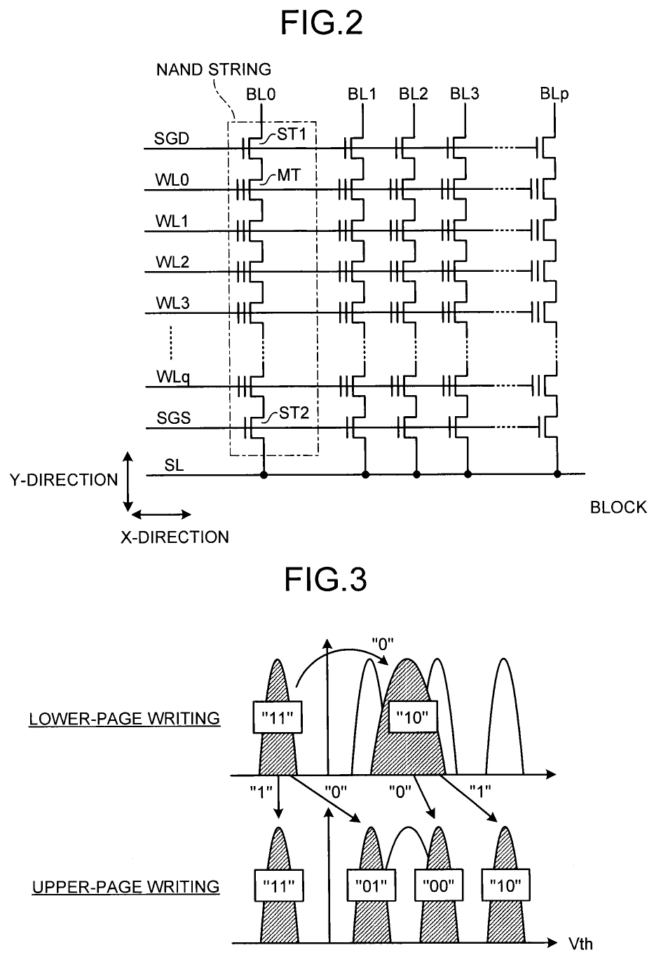

The memory cell array 10 includes a plurality of blocks serving as units of erasure. FIG. 2 is a circuit diagram illustrating a configuration example of one block included in the memory cell array 10. As illustrated in the figure, each block includes (m+1) NAND strings that are successively arranged along the X-direction (m is an integer of 0 or more). A selection transistor ST1 included in each of the (m+1) NAND string has a drain connected to bit lines BL0 to BLp and a gate connected in common to a selection gate line SGD. Moreover, a selection transistor ST2 has a source connected in common to a source line SL and a gate connected in common to a selection gate line SGS.

Each memory cell transistor MT includes metal oxide semiconductor field effect transistors (MOSFETs) that include a stacked gate structure formed on a semiconductor substrate. The stacked gate structure includes a charge storage layer (floating gate electrode) formed on the semiconductor substrate with a gate insulating film interposed and a control gate electrode formed on the charge storage layer with an inter-gate insulating film interposed. The memory cell transistor MT stores data according to a difference in a threshold value that changes according to the number of electrons that are stored in the floating gate electrode. The memory cell transistor MT may be configured to store one bit of data and may be configured to store multiple levels (two bits or more) of data.

In each NAND string, (n+1) memory cell transistors MTs are disposed such that the respective current paths are connected in series between the source of the selection transistor ST1 and the drain of the selection transistor ST2. Moreover, the control gate electrodes are connected to word lines WL0 to WLq in order from a memory cell transistor MT located closest to the drain side. Thus, a drain of a memory cell transistor MT connected to the word line WL0 is connected to the source of the selection transistor ST1, and a source of a memory cell transistor MT connected to the word line WLq is connected to the drain of the selection transistor ST2.

The word lines WL0 to WLq connect the control gate electrodes of the memory cell transistors MTs in common between NAND strings in a block. That is, the control gate electrodes of memory cell transistors MTs on the same row in a block are connected to the same word line WL. The (m+1) memory cell transistors MTs connected to the same word line WL are treated as one page, and writing and reading of data are performed in units of pages.

Moreover, the bit lines BL0 to BLp connect the drains of the selection transistors ST1 in common between blocks. That is, the NAND strings on the same column within a plurality of blocks are connected to the same bit line BL.

The memory cell array 10 can be a multi-level memory (MLC: Multi Level Cell) that stores two bits or more of data in one memory cell and can be a two-level memory (SLC: Single Level Cell) that stores one bit of data in one memory cell.

FIG. 3 illustrates an example of a threshold distribution in a 4-level data storage scheme in which two bits of data are stored in one memory cell transistor MT. According to the 4-level storage scheme, any one of four levels of data “xy” that are defined by an upper-page data “x” and a lower-page data “y” can be stored in one memory cell transistor MT. The four levels of data “xy” can be “11,” “01,” “00,” and “10,” for example, which are allocated in the order of the threshold value of the memory cell transistor MT. Data “11” is an erasure state of the memory cell transistor MT that has a negative threshold voltage.

In a lower-page writing operation, data “10” is selectively written to the memory cell transistors MTs having the data “11” (erasure state) by writing the lower-page data “y.” A threshold distribution of the data “10” before an upper-page writing operation is located approximately in the midpoint of the threshold distributions of the items of data “01” and “00” after the upper-page writing operation and may be broader than the threshold distribution after the upper-page writing operation.

In the upper-page writing operation, items of data “01” and “00” are written to the memory cells having the data “11” and the memory cells having the data “10,” respectively, by writing the upper-page data “x.”

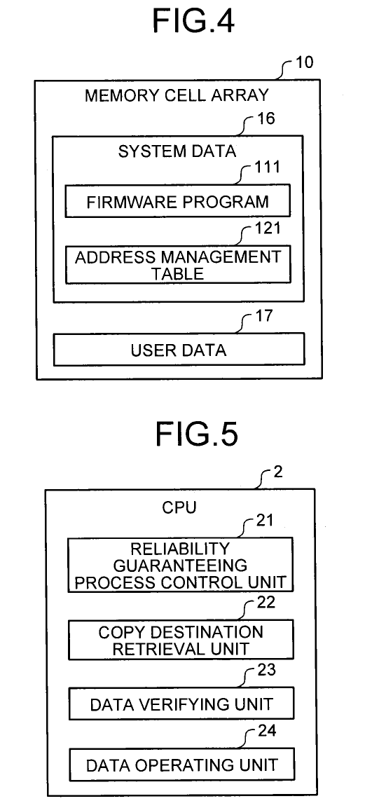

FIG. 4 is a view for describing data stored by the memory cell array 10. As illustrated in the figure, the memory cell array 10 stores a firmware program 111, an address management table 121, and user data 17 which is the writing data requested from the host device 200. The firmware program 111 is a program that enables the CPU 2 to execute control of the SSD 100, and the address management table 121 is a table that describes a correspondence between LBA and a physical address of the memory cell array 10.

A scheme described below, for example, is employed as a writing scheme of a NAND memory cell array 10. First, before writing data, invalid data in a block needs to be erased. That is, data can be sequentially written to non-written pages among erased blocks, and data is not overwritable to written pages. Moreover, as described above, a writing address that is requested from the host device 200 is designated as a logical address (LBA) that is used in the host device 200. On the other hand, a writing address of data to the NAND memory 1 is written in ascending order of pages based on a physical storage location (physical address) of the memory cell array 10. That is, the physical address is determined regardless of the logical address. A correspondence between the determined logical address and the determined physical address is recorded in the address management table 121. Moreover, when a new data writing request is received from the host device 200 while designating the same logical address as designated in a previous data writing request, the CPU 2 writes new data to a non-written page among erased blocks. In this case, the CPU 2 invalidates the page in which data has been written previously in the logical address and validates the page in which new data has been written.

Here, there is such a problem that with an increase in the number of times of writing and erasing of data to and from the memory cell array 10, an oxide film near the floating gate deteriorates, and the data written at that position is likely to change. Moreover, the data which has been written to the memory cell array 10 may change due to a program disturb or a read disturb, and an error may occur in the data. On the other hand, the firmware program 111 and the address management table 121 are items of data that are essential for the SSD 100 to function as an external storage device of the host device 200, and the integrity of the SSD 100 is damaged if these items of data are destroyed. Thus, it is preferable to prevent such a destruction that it is not possible to correct these items of data or to multiplex these items of data so that the SSD 100 operates properly even if these items of data are destroyed.

Therefore, in the first embodiment, the firmware program 111 and the address management table 121 (hereinafter collectively referred to as system data 16) are verified at a predetermined point in time, and when the verification result thereof is NG (not good), the system data 16 is moved to a different location in the memory cell array 10. A series of these processes will be referred to as a reliability guaranteeing process.

FIG. 5 is a view for describing a functional configuration of the SSD 100 for executing the reliability guaranteeing process. As illustrated in the figure, the CPU 2 includes a reliability guaranteeing process control unit 21, a copy destination retrieval unit 22, a data verifying unit 23, and a data operating unit 24. The reliability guaranteeing process control unit 21 controls the copy destination retrieval unit 22, the data verifying unit 23, and the data operating unit 24. The copy destination retrieval unit 22 retrieves a copying destination address of the system data 16. The data verifying unit 23 executes verification of the system data 16 before execution of the reliability guaranteeing process and verification of the copied system data 16. The data operating unit 24 executes operations such as copying of the system data 16 or erasure of copying target system data 16 (that is, system data 16 before execution of the reliability guaranteeing process). These functional configuration units are realized by the CPU 2 executing the firmware program 111.

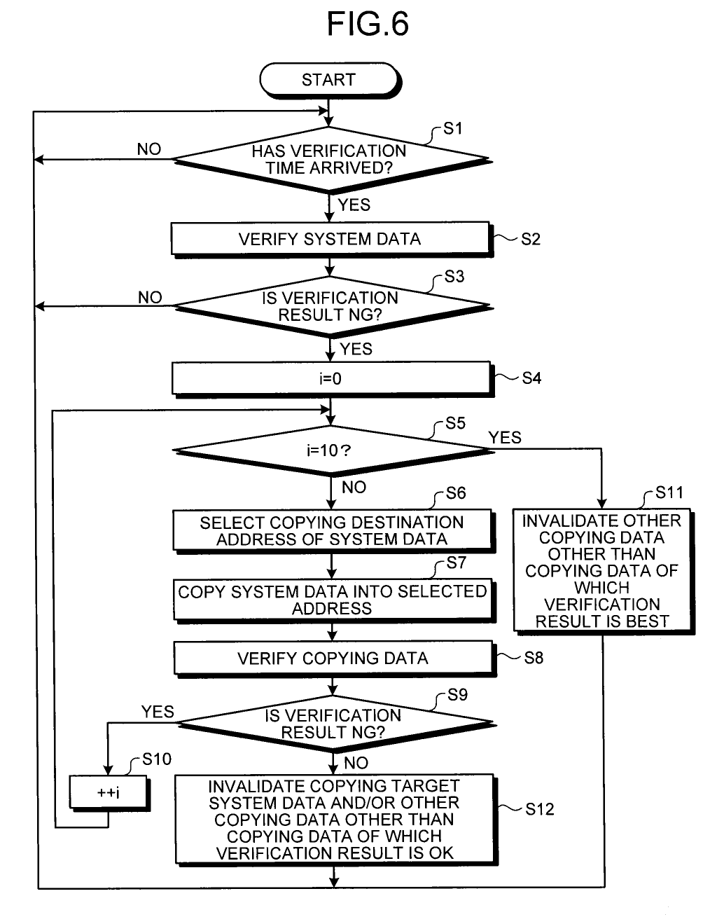

FIG. 6 is a flowchart for describing the reliability guaranteeing process of the SSD 100 according to the first embodiment.

First, the reliability guaranteeing process control unit 21 determines whether the present point in time has reached a verification time of the system data 16 (step S1). When the present point in time is not the verification time of the system data 16 (No in step S1), the reliability guaranteeing process control unit 21 executes the determination process of step S1 again. The verification time may be set to an optional point in time. For example, verification may be executed at predetermined intervals of time, and the time of power-off or the time of power-on may be set as the verification time.

When the present point in time has reached the verification time of the system data 16 (Yes in step S1), the data verifying unit 23 executes verification of the system data 16 according to an instruction from the reliability guaranteeing process control unit 21 (step S2). Verification of the system data 16 is executed as follows, for example. That is, the data verifying unit 23 instructs the NANDC 5 so that the system data 16 is transmitted (read) from the NAND memory 1 to the DRAM 4. When the system data 16 is transmitted, the ECC circuit 51 detects and corrects an error based on a first error correction code (ECC) and notifies the data verifying unit 23 of the number of errors that have been corrected using the first error correction code (ECC) when error correction is performed. Moreover, when there is an error that is not correctable, the ECC circuit 51 notifies of the data verifying unit 23 of the fact, and the data verifying unit 23 instructs the ECC circuit 6 so that the error that is not correctable using the first error correction code (ECC) is corrected using a second error correction code (ECC). The ECC circuit 6 notifies the data verifying unit 23 of the number of errors that have been corrected.

Subsequently, the data verifying unit 23 determines whether the verification result is NG (that is, the reliability of the system data 16 has decreased) (step S3). The determination of step S3 may be performed in an optional manner. For example, when the sum of the number of errors that have been corrected using the first error correction code (ECC) and the number of errors that have been corrected using the second error correction code (ECC) has reached a predetermined threshold value, the data verifying unit 23 may determine that the reliability of the system data 16 had decreased. When the sum has not reached the threshold value, the data verifying unit 23 may determine that the reliability of the system data 16 has not decreased. Moreover, the data verifying unit 23 may record the sum whenever the determination of step S2 is executed and may determine whether the reliability of the system data 16 has decreased based on whether the sum tends to increase. That is, the data verifying unit 23 may determine whether the reliability of the system data 16 has decreased using the present value and/or the past value of the sum.

When the verification result is OK (good) (No in step S3), the reliability guaranteeing process control unit 21 executes the process of step S1. When the verification result is NG (Yes in step S3), the reliability guaranteeing process control unit 21 initializes a loop index “i” used for the loop process of steps S5 to S10 to “0” (step S4) and determines whether i=10 (step S5). When i≠10 (No in step S5), the reliability guaranteeing process control unit 21 instructs the copy destination retrieval unit 22, and the instructed copy destination retrieval unit 22 selects a copying destination address of the system data 16 from empty areas (step S6). In this embodiment, a method of selecting an address from the empty areas is not limited to a specific method. For example, one of empty blocks (that is, blocks that do not contain valid data) may be used as a copying destination address.

Subsequently, the reliability guaranteeing process control unit 21 instructs the data operating unit 24, and the instructed data operating unit 24 copies the system data 16 into the address selected in step S6 (step S7). After that, the data verifying unit 23 executes verification of the system data 16 (hereinafter referred to as copying data) that is copied into the address selected in step S6 according to an instruction from the reliability guaranteeing process control unit 21 (step S8) and determines whether the verification result is NG (step S9). The process of step S8 may be the same as the process of step S2. Moreover, the process of step S9 is performed based on the sum of the number of errors that are corrected using the first error correction code (ECC) and the number of errors that are corrected using the second error correction code (ECC), obtained in the process of step S2. When the verification result is NG (Yes in step S9), the reliability guaranteeing process control unit 21 increases the loop index “i” by “1” (step S10) and executes the process of step S5.

Moreover, when i=10 (Yes in step S5), the reliability guaranteeing process control unit 21 instructs the data operating unit 24 to invalidate copying data other than the copying data of which the verification result is best (step S11). After that, the reliability guaranteeing process control unit 21 executes the determination process of step S1.

When the verification result of the copying data is OK (good) (No in step S12), the reliability guaranteeing process control unit 21 instructs the data operating unit 24 to invalidate the copying target system data 16 other than the copying data of which the verification result is OK (step S12). Here, whether there is copying data other than the copying data of which the verification result is OK, the reliability guaranteeing process control unit 21 instructs the data operating unit 24 to invalidate copying data other than the copying data of which the verification result is OK. The reliability guaranteeing process control unit 21 executes the determination process of step S1 after performing the process of step S12.

As described above, according to the first embodiment, the data verifying unit 23 reads the system data 16 stored in a predetermined address of the NAND memory 1 from the NAND memory 1 at a predetermined point in time and verifies the read system data 16. When the verification result obtained by the data verifying unit 23 is not good, the copy destination retrieval unit (the address selecting unit) 22 selects the copying destination address of the NAND memory 1, and the data operating unit 24 copies the system data into the selected copying destination address. Moreover, the data verifying unit 23 reads the copying data and verifies the read copying data. When the verification result of the copying data is a good, the data operating unit 24 erases the copying target system data 16. In this manner, since the SSD 100 can move the system data 16 into another address in which predetermined reliability is guaranteed before the integrity of the system data 16 is damaged, it is possible to reduce the risk that the system data 16 may not be read.

Moreover, since the data operating unit 24 does not erase the copying target system data 16 when the verification result of the copying data is not good, the SSD 100 can use the copying data as the system data 16 even when the copying target system data 16 is damaged such that errors may not be corrected. Thus, it is possible to reduce the risk that the system data 16 may not be read.

In the above description, although the data verifying unit 23 performs verification of the system data 16 or the copying data based on the number of corrected errors, verification may be performed based on the number of detected errors.

### Second Embodiment

In a second embodiment, the SSD 100 copies the system data 16 into a block in which the number of rewriting times (that is, the sum of the number of erasing times and the number of writing times) is the smallest and multiplexes the system data 16 when the reliability of the system data 16 has decreased.

A hardware configuration of the SSD 100 according to the second embodiment is the same as that of the first embodiment, and the operations of the individual functional configuration units are different. Thus, the second embodiment will be described using the constituent components of the first embodiment.

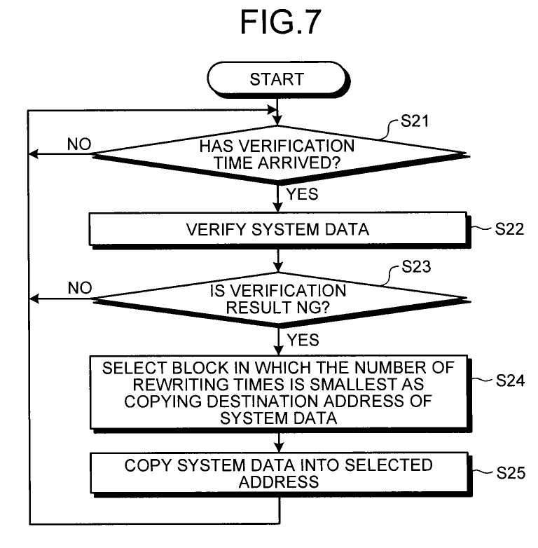

FIG. 7 is a flowchart for describing a reliability guaranteeing process of the SSD 100 according to the second embodiment. First, in the SSD 100 according to the second embodiment, in steps S21 and S22, the same processes as steps S1 and S2 described above are executed. Moreover, the data verifying unit 23 determines whether the verification result of the system data 16 is NG based on an instruction from the reliability guaranteeing process control unit 21 (step S23). When the verification result is NG (Yes in step S23), the reliability guaranteeing process control unit 21 instructs the copy destination retrieval unit 22, and the instructed copy destination retrieval unit 22 selects a block in which the number of rewriting times is smallest among empty blocks as a copying destination of the system data 16 (step S24). Then, the reliability guaranteeing process control unit 21 instructs the data operating unit 24, and the instructed data operating unit 24 copies the system data 16 into the block selected in step S24 (step S25). After the process of step S25 is performed, or when the verification result is OK (No in step S23), the reliability guaranteeing process control unit 21 executes a determination process of step S21.

As described above, according to the second embodiment, the data verifying unit 23 reads the system data 16 stored in a predetermined block of the NAND memory 1 and verifies the read system data 16. When the verification result is not good, the copy destination retrieval unit 22 selects a block in which the number of rewriting times is smallest as the copying destination of the system data 16, and the data operating unit 24 copies the system data 16 into the selected block in which the number of rewriting times is smallest. Thus, even when the copying target system data 16 is damaged such that errors may not be corrected, since the SSD 100 can use the copying data as the system data 16, it is possible to reduce the risk that the system data 16 may not be read. Moreover, although in the first embodiment, the SSD 100 performs verification of the copying data, according to the second embodiment, since the SSD 100 does not perform verification of the copying data, it is possible to reduce the cost required for the reliability guaranteeing process.

### Third Embodiment

Although in the first embodiment, the copy destination retrieval unit 22 selects the copying destination address of the system data 16 based on an optional method, the copy destination retrieval unit 22 may select a block in which the number of rewriting times is smallest among empty blocks as the copying destination address as in the second embodiment. By doing so, since the system data 16 can be copied into an address in which the integrity is as high as possible, it is possible to reduce the number of execution times of the loop process of steps S5 to S10 in one instance of the reliability guaranteeing process.

Moreover, in the first and second embodiments, the copy destination retrieval unit 22 retrieves the copying destination address from empty areas. However, the copy destination retrieval unit 22 may select a page subsequent to valid data, of a block in which valid data is written halfway to a page as the copying destination address.

Furthermore, in the second embodiment, the copy destination retrieval unit 22 selects a block in which the number of rewriting times is smallest among empty blocks as a copying destination block of the system data 16. However, when the block in which the number of rewriting times is smallest among all blocks is a block that contains valid data, the copy destination retrieval unit 22 may move the valid data written to the block into another empty block and then select the block that becomes an empty block as the copying destination of the system data 16.

Furthermore, in the first embodiment, the data operating unit 24 multiplexes the system data 16 when the verification result of the copying data does not become OK even when the loop process of steps S5 to S10 is performed ten times. By using the fact that data that is written in an SLC mode is less likely to disappear than data that is written in an MLC mode, the reliability guaranteeing process control unit 21 may execute control as follows. That is, in an initial state, the system data 16 is written in an MLC mode, and when the verification result of the copying data does not become OK even when the loop process of steps S5 to S10 is performed ten times, the reliability guaranteeing process control unit 21 may instruct the data operating unit 24, and the instructed data operating unit 24 may copy the system data 16 in an SLC mode. When the system data 16 is copied in an SLC mode, the reliability guaranteeing process control unit 21 may instruct the data operating unit 24 to erase the original system data 16 or to leave the original system data 16 as it is.

### Fourth Embodiment

Since a hardware configuration of an SSD according to a fourth embodiment is the same as that of the first embodiment, description of the hardware configuration will not be provided herein. In the fourth embodiment, the NAND memory 1 functions as a first memory, and the DRAM 4 functions as a second memory.

The DRAM 4 is a volatile memory that functions as a working area for allowing the CPU 2 to control the SSD 100. In particular, the address management table 121 (described later) in which a correspondence between an LBA and the physical address of the NAND memory 1 is recorded is loaded (stored) on the DRAM 4. The address management table 121 loaded on the DRAM 4 is updated by the CPU 2 whenever the correspondence between the LBA and the physical address of the NAND memory 1 is updated.

Moreover, in the fourth embodiment, when the ECC circuit 51 detects an error that may not be corrected even when the first error correction code (ECC) is decoded, the ECC circuit 51 notifies the CPU 2 of the fact. The notified CPU 2 starts the ECC circuit 6 to execute error correction based on the second error correction code (ECC).

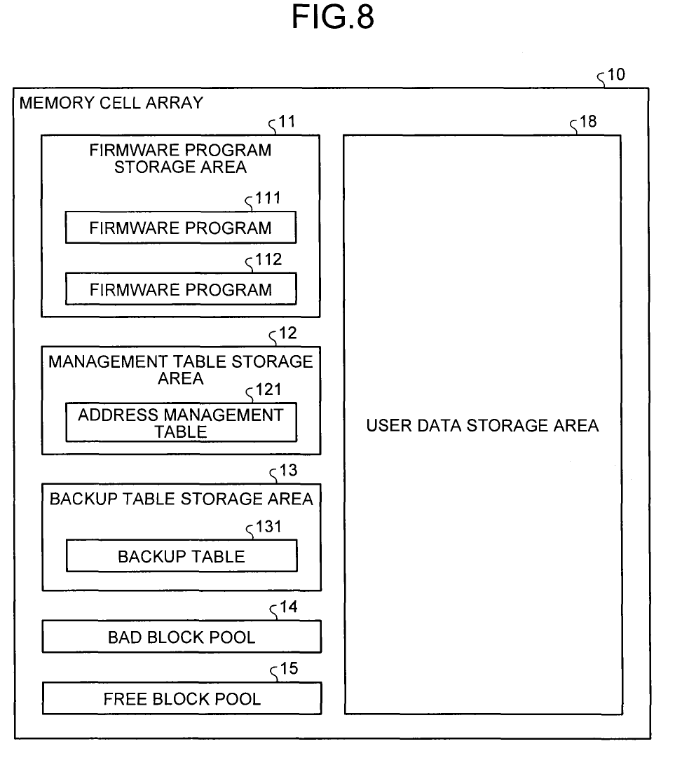

FIG. 8 is a view for describing a memory configuration of the memory cell array 10. As illustrated in the figure, the memory cell array 10 includes a user data storage area 18, a firmware program storage area 11, a management table storage area 12, a backup table storage area 13, a bad block pool 14, and a free block pool 15.

The user data storage area 18 is an area in which data (user data) that is the writing data requested from the host device 200 is stored. A predetermined range on an LBA space is allocated to the user data storage area 18. The LBA is not allocated to the firmware program storage area 11, the management table storage area 12, the backup table storage area 13, the bad block pool 14, and the free block pool 15.

The firmware program 111 and the firmware program 112 which is backup data of the firmware program 111 are stored in the firmware program storage area 11. Upon start-up, the CPU 2 reads and uses the firmware program 111. When an error that may not be corrected is present in the firmware program 111, the CPU 2 reads and uses the firmware program 112.

The management table storage area 12 is an area in which the address management table 121 is stored. The address management table 121 on the DRAM 4 is written to a free block at a predetermined point in time (in this example, the time of power-off) and is made nonvolatile.

The free block pool 15 is a set of free blocks which are blocks that do not contain valid data. Free blocks registered in the free block pool 15 are free blocks (second good blocks) to which the LBA is not allocated. Moreover, the bad block pool 14 is a set of bad blocks (fault blocks) which are blocks that are determined to be unusable by the CPU 2.

In the fourth embodiment, when a read error, an erasure error, or a program error, for example, occurs, the CPU 2 registers blocks in which these errors occur in the bad block pool 14 as bad blocks. When a block (first good block) that constitutes the user data storage area 18 becomes a bad block, and the bad block is added to the bad block pool 14, the same number of free blocks as the number of blocks added to the bad block pool 14 are taken out of the free block pool 15 and added to the user data storage area 18. As a result, the user data storage area 18 can always maintain the same size even when some of the blocks that constitute the user data storage area 18 become bad blocks. That is, it is possible to always provide the user data storage area 18 of the same size to the host device 200. Since it is not possible to always provide the user data storage area 18 of the same size to the host device 200 when the free blocks registered in the free block pool 15 are used up, the SSD 100 becomes unusable.

When the address management table 121 on the DRAM 4 is made nonvolatile, the address management table 121 is stored in a free block that is registered in the free block pool 15, and the free block becomes the management table storage area 12. When a new address management table 121 is written to a free block, the address management table 121 in a block that has been used as the management table storage area 12 in which the address management table 121 is stored is invalidated, and the block is returned to the free block pool 15. The free block registered in the free block pool 15 may be added to the user data storage area 18 and may be removed from the user data storage area 18 and added to the free block pool 15 according to wear leveling or garbage collection.

The backup table storage area 13 is configured by a bad block, and the backup table 131 which is backup data of the address management table 121 is stored in the backup table storage area 13.

For example, since a block which becomes a bad block due to the occurrence of a read error caused by the progress of data retention and the occurrence of a read error caused by the influence of a program disturb does not actually damage the integrity of a memory cell array, the data stored in the block can be reused by erasing the data. Since the SSD 100 according to the fourth embodiment of the present invention multiplexes and stores the management data in a block that can be reused among bad blocks, it is possible to prevent the occurrence of such a disability for the SSD 100 not to start due to a destruction of the management data. As described above, the free blocks registered in the free block pool 15 are consumed when the block that constitutes the user data storage area 18 becomes a bad block, and it becomes not possible to further use the SSD 100 when the free blocks of the free block pool 15 are used up. According to the fourth embodiment of the present invention, since a management table is backed up in a block that becomes a bad block, it is possible to further increase the number of blocks that can be used as the user data storage area 18 in future as compared to a case where a new free block is prepared for backup. Thus, it is possible to extend the period before the SSD 100 becomes unusable.

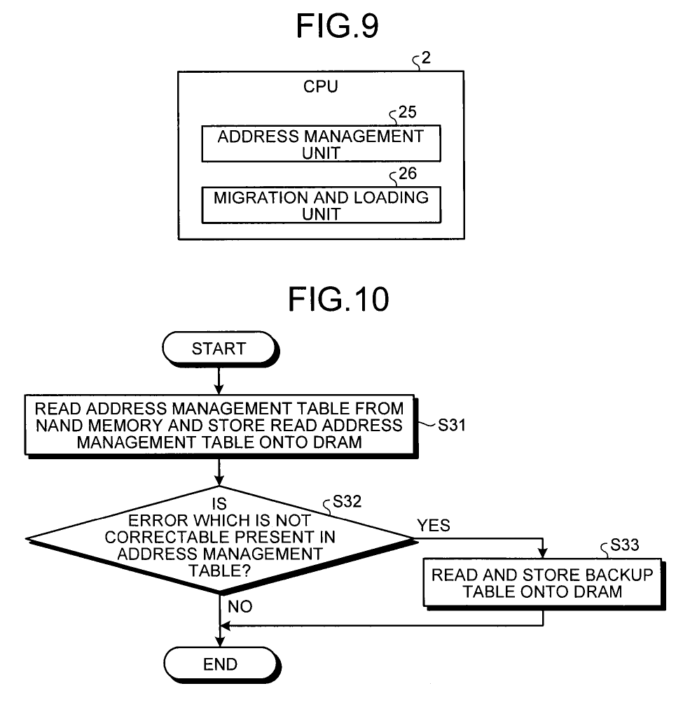

FIG. 9 is a view for describing a functional configuration of the SSD 100 according to the fourth embodiment, which is implemented when the CPU 2 executes the firmware program 111 or the firmware program 112. As illustrated in the figure, the CPU 2 includes an address management unit 25 and a migration and loading unit 26.

The address management unit 25 updates the address management table 121 on the DRAM 4 whenever writing data as requested by the host device 200 is written into the user data storage area 18. Moreover, the address management unit 25 may perform wear leveling or garbage collection and update the address management table 121 on the DRAM 4 whenever the wear leveling or the garbage collection is performed. That is, the address management unit 25 updates and manages the address management table 121 on the DRAM 4.

The migration and loading unit 26 loads the address management table 121 stored in the management table storage area 12 onto the DRAM 4 and migrates the address management table 121 stored in the DRAM 4 onto the NAND memory 1. The migration and loading unit 26 updates a backup table 131 whenever migrating the address management table 121 on the DRAM 4.

FIG. 10 is a flowchart for describing the power-on operation of the SSD 100. When the SSD 100 is powered on, the migration and loading unit 26 reads the address management table 121 from the NAND memory 1 (precisely, the management table storage area 12) and loads the read address management table 121 onto the DRAM 4 (step S31). Here, when the address management table 121 is read from the NAND memory 1, detection and correction of errors are performed by the ECC circuit 51, or the ECC circuit 51 and the ECC circuit 6. The migration and loading unit 26 determines whether there is an error which may not be corrected even using the ECC circuit 6 (step S32). When the address management table 121 includes an error which may not be corrected even using the ECC circuit 6 (Yes in step S32), the migration and loading unit 26 reads the backup table 131 stored in the backup table storage area 13 and stores the read backup table 131 in the DRAM 4 as the address management table 121 (step S33). When there is not the error which may not be corrected even using the ECC circuit 6 (No in step S32), the process of step S33 is skipped. Moreover, the migration and loading unit 26 ends the process during startup, of the SSD 100. After the process during startup, of the SSD 100 ends, whenever a correspondence between an LBA and a physical address corresponding to user data changes, the address management unit 25 causes the amount of change in the correspondence to be reflected on the address management table 121 on the DRAM 4. The change in the correspondence between the LBA and the physical address occurs when new user data is written from the host device 200 or when garbage collection or wear leveling is executed.

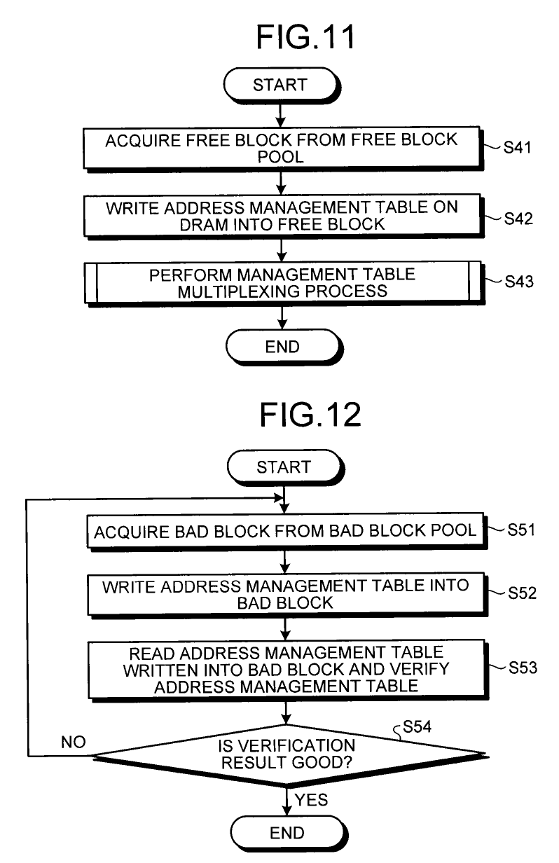

FIG. 11 is a flowchart for explaining the power-off operation of the SSD 100. When the SSD 100 is powered off, the migration and loading unit 26 acquires one free block from the free block pool 15 (step S41). Moreover, the migration and loading unit 26 writes the address management table 121 on the DRAM 4 into the free block acquired in the process of step S41 (step S42). By this process, the block in which the address management table 121 is written becomes the management table storage area 12, and the block that constitutes the previous management table storage area 12 is added to the free block pool 15 with the data stored in the block being invalidated. Subsequently, the migration and loading unit 26 executes a management table multiplexing process of multiplexing the address management table 121 (step S43), and the power-off operation of the SSD 100 ends.

FIG. 12 is a flowchart for explaining the management table multiplexing process according to the fourth embodiment. The migration and loading unit 26 acquires one bad block from the bad block pool 14 (step S51). Moreover, the migration and loading unit 26 writes the address management table 121 on the DRAM 4 into the bad block acquired in the process of step S51 (step S52). Moreover, the migration and loading unit 26 reads the address management table 121 written in the bad block in the process of step S52 onto the DRAM 4, for example, to thereby verify the address management table 121 written in the bad block (step S53). The migration and loading unit 26 can verify the address management table 121 written to the bad block by allowing the ECC circuit 6 to monitor whether there is an error that the ECC circuit 6 may not correct using a second error correction code when reading the address management table 121. That is, the migration and loading unit 26 may determine that the address management table 121 is not good when an error that the ECC circuit 6 may not correct using the second error correction code occurs in the address management table 121 written to the bad block. The migration and loading unit 26 may determine that the address management table 121 is good when an error that the ECC circuit 6 may not correct using the error correction code does not occur in the address management table 121 written to the bad block. When the verification result of the address management table 121 written into the bad block in the process of step S52 is not good (No in step S54), the migration and loading unit 26 executes the process of step S51 again. When the verification result of the address management table 121 written into the bad block in the process of step S52 is good (Yes in step S54), the migration and loading unit 26 ends the management table multiplexing process. The address management table 121 which is written into the bad block and of which the verification result is good is stored in the bad block as the backup table 131, and the bad block becomes the backup table storage area 13.

In the above description, in order to simplify the description, although the address management table 121 is described as being filled into one block, the size of the address management table 121 may exceed the size of one block. In that case, the migration and loading unit 26 may divide and store the backup table 131 in a plurality of bad blocks.

Moreover, although the address management table 121 is backed up, the management data that is used by being loaded onto the DRAM 4, such as a bad block list or a free block list, may be backed up.

As described above, according to the fourth embodiment, the SSD 100 is configured such that the address management table 121 is read from the DRAM 4 at a predetermined point in time, the read address management table 121 is migrated into the free block, and the backup table 131 which is copying data of the migration target address management table 121 is written into the bad block. Thus, since the backup table 131 written into the bad block can be used as the address management table 121 even when the address management table 121 is destroyed, the reliability of the SSD 100 is improved. Further, since the SSD 100 uses the bad block rather than the free block as a writing destination of the backup table 131, it is possible to extend the period before the SSD 100 becomes unusable.

Moreover, the SSD 100 is configured such that after the backup table 131 is written into the bad block, the SSD 100 verifies the backup table 131 written into the bad block, and stores the backup table 131 into another bad block when the verification result of the backup table 131 is not good. Thus, since the backup table 131 in which there is not an error which is not correctable can be prepared, the reliability of the SSD 100 is improved.

### Fifth Embodiment

When a specific word line in a block is faulty, the block becomes a bad block even if the other word lines are usable. According to a fifth embodiment, it is possible to store backup data in a non-faulty word line in a bad block in which only a specific word line is faulty.

Since the configuration of an SSD according to the fifth embodiment is the same as that of the fourth embodiment, the constituent components of the SSD according to the fifth embodiment will be referred using the same names and the same reference numerals as those of the fourth embodiment, and redundant description thereof will not be provided.

The operation of the SSD 100 according to the fifth embodiment is different from that of the fourth embodiment only for the management data multiplexing process.

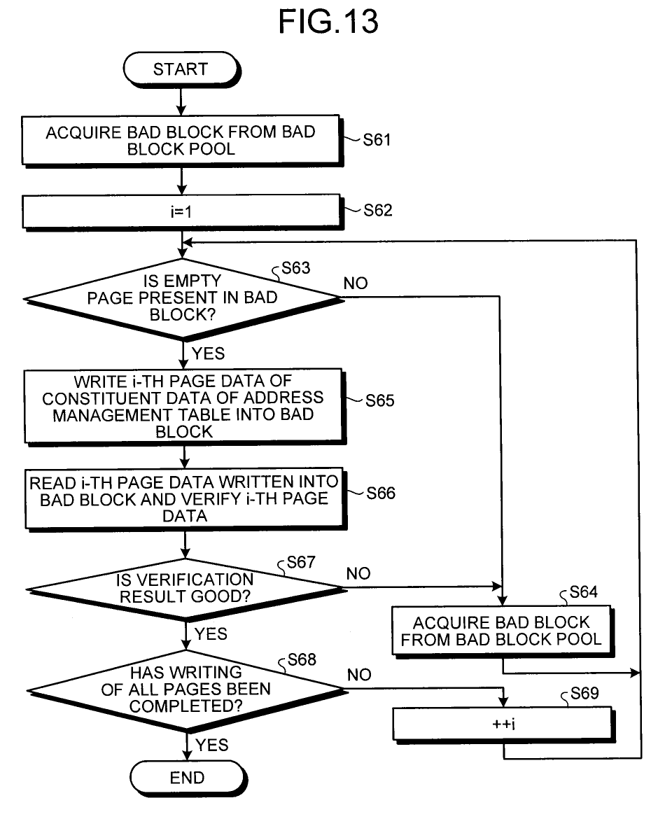

FIG. 13 is a flowchart for explaining the management table multiplexing process according to the fifth embodiment. First, the migration and loading unit 26 acquires one bad block from the bad block pool 14 (step S61). Moreover, the migration and loading unit 26 initializes the loop index “i” used for the loop process of steps S63 to S69 to “1” (step S62) and determines whether an empty page is present in the bad block acquired in the process of step S61 (step S63). The empty page referred in the process of step S63 means a page in which a writing operation in the process of step S65 described later has not been tried. When an empty page is not present in the bad block (No in step S63), the migration and loading unit 26 acquires another bad block from the bad block pool 14 (step S64) and executes the determination process of step S63 again. When an empty page is present in the bad block (Yes in step S63), the migration and loading unit 26 writes i-th page data among items of data that constitute the address management table 121 on the DRAM 4 into the empty page of the bad block (step S65). In step S65, the migration and loading unit 26 writes the i-th page data into a page of which the physical address is subsequent from a page in which data has been previously written. Subsequently, the migration and loading unit 26 reads the i-th page data written into the bad block in the process of step S65 onto the DRAM 4 and verifies the read i-th page data (step S66). A verification method in the process of step S66 may be the same as the verification method in the process of step S23.

Subsequently, the migration and loading unit 26 determines whether the verification result obtained in the process of step S66 is good (step S67). When the verification result of the i-th page data written into the bad block in the process of step S65 is not good (No in step S67), the migration and loading unit 26 executes the process of step S64. As a result, when the verification result of the i-th page data is not good, the migration and loading unit 26 changes a writing destination bad block of the i-th page data to another bad block.

When the verification result of the i-th page data written into the bad block in the process of step S65 is good (Yes in step S67), the migration and loading unit 26 determines whether all items of data that constitute the address management table 121 on the DRAM 4 have been written into the bad block (step S68). When there is data which has not been written into the bad block (No in step S68), the migration and loading unit 26 increases the loop index “i” by “1” (step S69) and executes the process of step S63. As a result, when the verification result of the i-th page data is good, the migration and loading unit 26 writes the (i+1)-th page data, that is, data subsequent to the i-th page data, into a subsequent word line (that is, a page corresponding to the subsequent physical address) in the same bad block as the i-th page data.

When data which has not been written into the bad block is not present (Yes in step S68), the migration and loading unit 26 ends the management table multiplexing process according to the fifth embodiment.

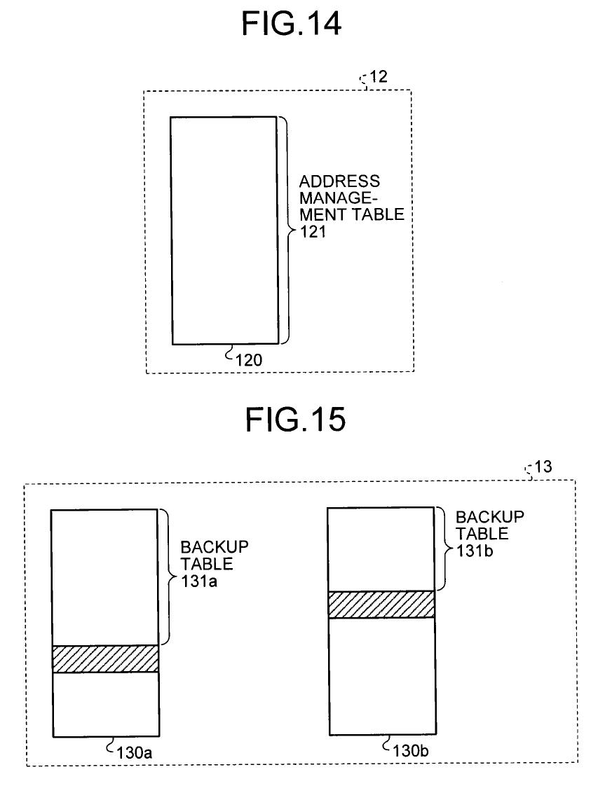

FIG. 14 is a view for explaining a configuration example of the management table storage area 12, and FIG. 15 is a view for explaining a configuration example of the backup table storage area 13 according to the fifth embodiment. When the address management table 121 has such a size that the address management table 121 can be stored in one block 120 as illustrated in FIG. 14, the backup table 131 is divided into a plurality of (in this example, two) backup tables 131a and 131b by the management table multiplexing process according to the fifth embodiment as illustrated in FIG. 15, and the divided backup tables 131a and 131b are stored in bad blocks 130a and 130b, respectively. A hatched portion depicted in the bad blocks 130a and 130b represents a faulty location. That is, according to the fifth embodiment, the backup table 131 is written into a location immediately before a faulty location of the bad block 130a to generate the backup table 131a, and the backup table 131b which is the remaining portion is written to a non-faulty location of the bad block 130b.

In this embodiment, the migration and loading unit 26 writes items of data that constitute the backup table 131 into the bad block in units of page size (word line size) and verifies the written data of the page size. However, the unit size of the data that is written into the bad block and verified by the migration and loading unit 26 may be not the same as the page size if the size is smaller than the block size. For example, the unit size of the data that is written into the bad block and verified by the migration and loading unit 26 may be a multiple of a natural number of the page size.

As described above, according to the fifth embodiment, the SSD 100 writes the backup table 131 into the bad block in units of constituent data of a unit size that is smaller than the block size. Moreover, the SSD 100 writes the constituent data into the bad block and verifies the constituent data written into the bad block. When the verification result of the constituent data is good, the SSD 100 stores constituent data subsequent to the constituent data in a subsequent physical address of the same bad block. When the verification result of the constituent data is not good, the SSD 100 writes the constituent data of which the verification result is not good into another bad block. As a result, the SSD 100 can use a non-faulty portion of the bad block that is partially faulty as a storage destination of the backup table 131. That is, it is possible to use the bad block efficiently.

### Sixth Embodiment

According to a sixth embodiment, it is possible to verify all word lines that constitute the bad block and store the backup table in a word line of which the verification result is good.

Since the configuration of an SSD according to the sixth embodiment is the same as that of the fourth embodiment, the constituent components of the SSD according to the sixth embodiment will be referred using the same names and the same reference numerals as those of the fourth embodiment, and redundant description thereof will not be provided.

The operation of the SSD 100 according to the sixth embodiment is different from that of the fourth embodiment only for the management data multiplexing process.

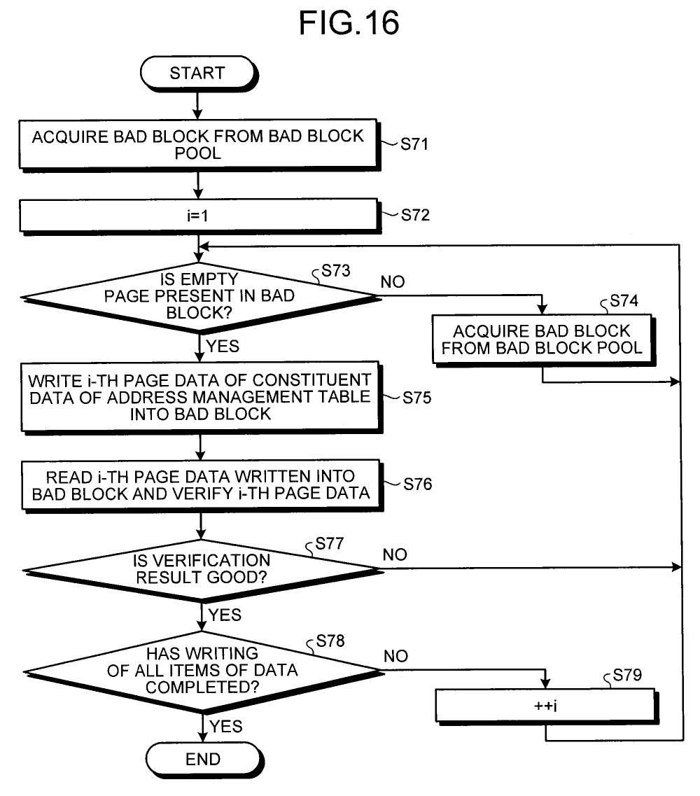

FIG. 16 is a flowchart for describing the management table multiplexing process according to the sixth embodiment. First, the migration and loading unit 26 acquires one bad block from the bad block pool 14 (step S71). Moreover, the migration and loading unit 26 initializes the loop index “i” used for the loop process of steps S73 to S79 to “1” (step S72) and determines whether an empty page is present in the bad block acquired in the process of step S71 (step S73). The empty page referred in the process of step S73 means a page in which a writing operation in the process of step S75 described later has not been tried. When an empty page is not present in the bad block (No in step S73), the migration and loading unit 26 acquires another bad block from the bad block pool 14 (step S74) and executes the determination process of step S73 again. When an empty page is present in the bad block (Yes in step S73), the migration and loading unit 26 writes i-th page data among items of data that constitute the address management table 121 on the DRAM 4 into the empty page of the bad block (step S75). Subsequently, the migration and loading unit 26 reads the i-th page data written into the bad block in the process of step S75 onto the DRAM 4 and verifies the read i-th page data (step S76). A verification method in the process of step S76 may be the same as the verification method in the process of step S23.

Subsequently, the migration and loading unit 26 determines whether the verification result obtained in the process of step S76 is good (step S77). When the verification result of the i-th page data written into the bad block in the process of step S75 is not good (No in step S77), the migration and loading unit 26 executes the process of step S73. When the loop process of No in steps S73 to S77 is performed repeatedly, items of data that constitute the address management table 121 are written into the usable word lines in the bad block. That is, when the verification result of the i-th page data is not good, the migration and loading unit 26 changes a writing destination of the i-th page data to a subsequent physical address of the same bad block.

When the verification result of the i-th page data written to the bad block in the process of step S75 is good (Yes in step S77), the migration and loading unit 26 determines whether all items of data that constitute the address management table 121 on the DRAM 4 have been written into the bad block (step S78). When there is data which has not been written into the bad block (No in step S78), the migration and loading unit 26 increases the loop index “i” by “1” (step S79) and executes the process of step S73. When data which has not been written into the bad block is not present (Yes in step S78), the migration and loading unit 26 ends the management table multiplexing process according to the sixth embodiment.

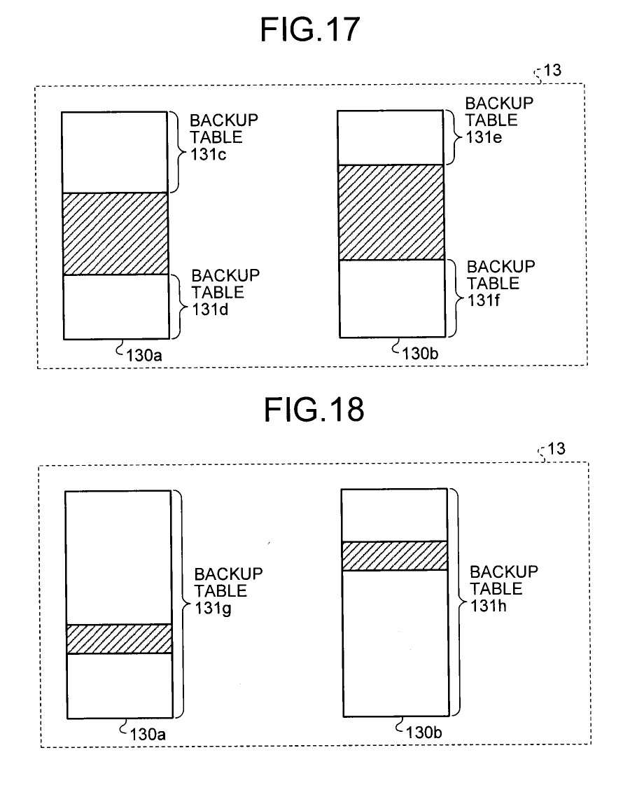

FIG. 17 is a view for explaining a configuration example of the backup table storage area 13 according to the sixth embodiment. As illustrated in the figure, backup tables 131c to 131f are stored in a state of being distributed in the usable areas of the bad blocks 130a and 130b. In particular, according to the sixth embodiment, as in the backup tables 131d and 131f, even when usable areas are present with a faulty area interposed to be separated from the beginning of the bad block, it is possible to store the backup tables in these areas.

In this manner, according to the sixth embodiment, the SSD 100 writes constituent data having a unit size that constitutes the address management table 121 into the bad block and then verifies the constituent data written to the bad block. When the verification result of the constituent data is good, the SSD 100 stores constituent data subsequent to the constituent data in a subsequent physical address of the same bad block. When the verification result of the constituent data is not good, the SSD 100 changes the writing destination of the constituent data of which the verification result is not good to a subsequent physical address of the same bad block. As a result, the SSD 100 can use a non-faulty portion of the bad block that is partially faulty as a storage destination of the backup table 131 more efficiently than the fifth embodiment.

### Seventh Embodiment

Since the configuration of an SSD according to the seventh embodiment is the same as that of the fourth embodiment, the constituent components of the SSD according to the seventh embodiment will be referred using the same names and the same reference numerals as those of the fourth embodiment, and redundant description thereof will not be provided.

FIG. 18 is a configuration example of the backup table storage area 13 according to the seventh embodiment. In the figure, backup tables 131g and 131h are items of copying data that are generated from the same address management table 121. That is, the backup table 131 is multiplexed. As illustrated in the figure, the backup tables 131g and 131h are written into the bad blocks 130a and 131b regardless of whether the word line is usable or faulty, and when the address management table 121 stored in the management table storage area 12 is destroyed, and the backup table 131 is necessary, items of partial data that are written into a usable area of the backup tables 131g and 131h are loaded onto the DRAM 4.

The operation of the SSD 100 according to the seventh embodiment is different from that of the fourth embodiment in terms of the management data multiplexing process and the power-on operation.

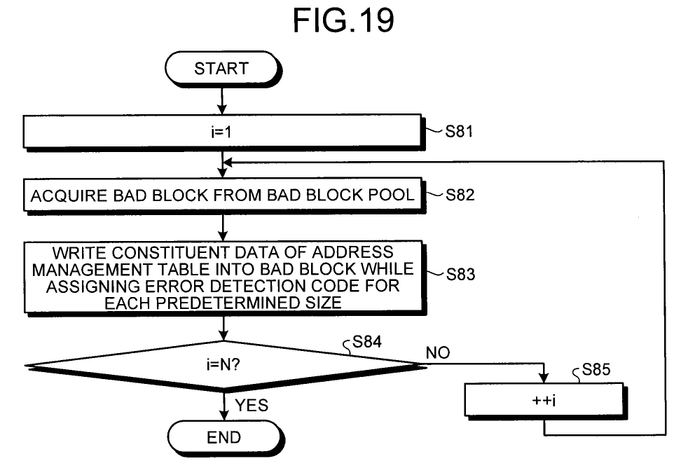

FIG. 19 is a flowchart describing the management table multiplexing process according to the seventh embodiment. First, the migration and loading unit 26 initializes the loop index “i” used for the loop process of steps S82 to S85 to “1” (step S81) and acquires one bad block from the bad block pool 14 (step S82). Moreover, the migration and loading unit 26 writes items of data that constitute the address management table 121 on the DRAM 4 into the bad block acquired in the process of step S82 while assigning an error detection code for each predetermined size of data (step S83). The error detection code assigned to the items of data that constitute the address management table 121 may be an optional code. The error detection code may be a check-sum code, a Hamming code, a Bose Chaudhuri Hocqenghem (BCH) code, a Reed Solomon (RS) code, a low density parity check (LDPC) code, or hash data, for example. Moreover, the migration and loading unit 26 determines whether the loop index “i” is identical to a predetermined natural number “N” (step S84). The natural number “N” is a value that describes how the backup table 131 will be multiplexed, and for example, the number is set to N=3 when the backup table 131 is multiplexed into three tables. When the loop index “i” is not identical to “N” (No in step S84), the migration and loading unit 26 increases the loop index “N” by “1” (step S85) and executes the process of step S82. When the loop index “i” is identical to “N” (Yes in step S85), the migration and loading unit 26 ends the management table multiplexing process according to the seventh embodiment.

In this way, the backup table 131 is stored by being multiplexed into N tables.

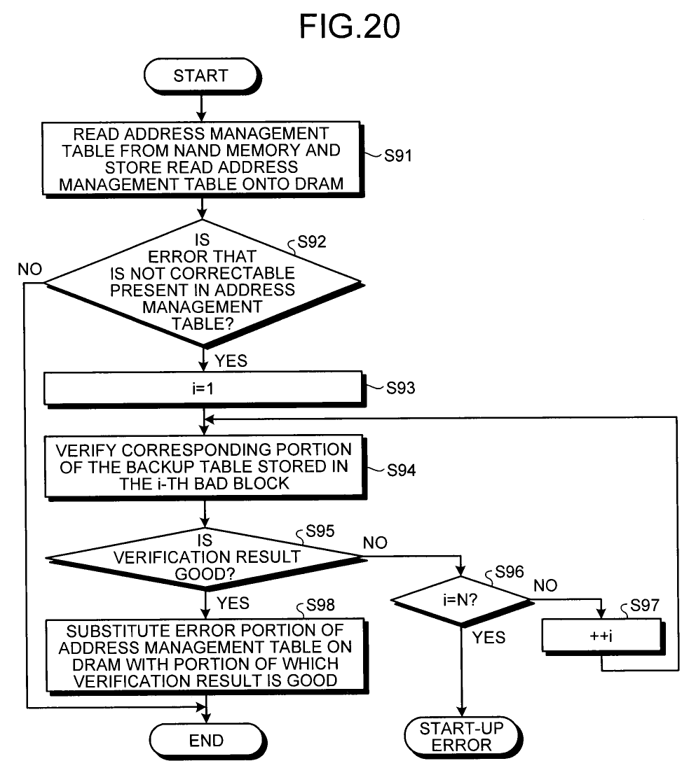

FIG. 20 is a flowchart describing the power-on operation of the SSD 100 according to the seventh embodiment. When the SSD 100 is powered on, the migration and loading unit 26 reads the address management table 121 from the NAND memory 1 and loads the read address management table 121 onto the DRAM 4 (step S91). Here, when the address management table 121 is read from the NAND memory 1, detection and correction of errors are performed by the ECC circuit 51, or the ECC circuit 51 and the ECC circuit 6. The migration and loading unit 26 determines whether there is an error which is not correctable even using the ECC circuit 6 (step S92). When there is an error which is not correctable even using the ECC circuit 6 (Yes in step S92), the migration and loading unit 26 initializes the loop index “i” used for the loop process of steps S94 to S97 to “1” (step S93). Then, the migration and loading unit 26 reads a portion of the backup table 131 stored in the i-th bad block that constitutes the backup table storage area 13, the portion corresponding to a location in which the error that is not correctable in step S92 is included, and verifies the portion (step S94). The portion that is read and verified in this step is partial data of the unit to which the error detection code is assigned in step S83, and an error detection code assigned to the partial data is used for the verification.

Subsequently, the migration and loading unit 26 determines whether the verification result of the partial data is good (step S95). When the verification result of the partial data is not good (No in step S95), the migration and loading unit 26 determines whether the loop index “i” is identical to the same natural numeral as the value used in step S84 (step S96). When the loop index “i” is not identical to “N” (No in step S96), the migration and loading unit 26 increases the loop index “i” by “1” (step S97) and executes the process of step S94. When the loop index “i” is identical to “N” (Yes in step S96), a startup error occurs.

When the verification result of the partial data is good (Yes in step S95), the migration and loading unit 26 substitutes the error portion of the address management table 121 on the DRAM 4 with the partial data (step S98) and ends the power-on operation. Moreover, when an error that is not correctable is not present in the address management table 121 (No in step S92), the migration and loading unit 26 ends the power-on operation.

As described above, according to the seventh embodiment, the SSD 100 prepares a plurality of backup tables 131, and verifies partial data corresponding to a destroyed portion, included in the backup table 131 for each of the backup tables 131 when the address management table 121 is destroyed. When the verification result of the partial data is good, the SSD 100 writes the partial data of which the verification result is good on the DRAM 4 based on the destroyed portion as a substitute for the destroyed portion. Thus, the operation of verifying the backup table 131 which is necessary in the fourth to sixth embodiments when preparing the backup table 131 is not necessary. Therefore, it is possible to reduce the cost of the power-off process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory that stores system data into a first address;
a first data verifying unit that reads the system data from the first address at a predetermined point in time and verifies the system data read from the first address;
an address selecting unit that selects a second address of the nonvolatile memory different from the first address when a verification result obtained by the first data verifying unit is not good;
a first data operating unit that copies the system data stored in the first address into the second address;
a second data verifying unit that reads the system data copied into the second address and verifies the system data read from the second address; and
a second data operating unit that erases the system data stored in the first address when a verification result obtained by the second data verifying unit is good.

2. The memory system according to claim 1, wherein
the second data operating unit does not erase the system data stored in the first address when the verification result obtained by the first data verifying unit is not good.

3. The memory system according to claim 1, wherein
the first and second data verifying units perform error detection or error correction on the system data read from the first or second address to verify the system data read from the first or second address based on the number of detected errors or the number of corrected errors.

4. The memory system according to claim 3, wherein
the address selecting unit selects a block in which the number of rewriting times is smallest as the second address.

5. The memory system according to claim 1, wherein
the address selecting unit selects a new address as the second address whenever the verification is performed until the verification result obtained by the second data verifying unit becomes good or the number of verification times obtained by the second data verifying unit reaches a predetermined number.

6. The memory system according to claim 5, wherein
the system data stored in the first address is stored in an MLC (multi level cell) mode, and when the number of verification times reaches the predetermined number, the second data verifying unit copies the system data stored in the first address into any one of the second selected addresses in an SLC (single level cell) mode.

7. A memory system comprising:
a nonvolatile memory in which data is stored in a first location; and
a determining unit that determines a second location with reference to a verification result of the data read from the first location, wherein
the memory system writes the data read from the first location into the second location, and erases the data stored in the first location with reference to a verification result of the data read from the second location.

8. The memory system according to claim 7, wherein
the determining unit determines the second location with reference to the number of rewriting times of a block.

9. A memory system comprising:
a first non-transitory memory that includes a first block and a second block and stores data into the first block; and
a second non-transitory memory that stores an address management table in which a logical address and a physical address of the first block are correlated, wherein
the memory system reads the address management table from the second non-transitory memory and writes the address management table into another first block different from the first block, and writes the address management table into the second block.

10. The memory system according to claim 9, wherein
after the copying data is written into the second block, the memory system verifies the copying data written into the second block, and when a verification result is not good, the memory system changes the writing destination of the copying data to another second block.

11. The memory system according to claim 9, wherein
the memory system
writes the copying data the second block for each constituent data that has a size smaller than the first block,
after the writing first constituent data into the second block, verifies the first constituent data written into the second block,
writes second constituent data subsequent to the first constituent data into a physical address subsequent to a physical address which is a writing destination of the first constituent data when a verification result is good,
changes the writing destination of the first constituent data to another second block when the verification result is not good.

12. The memory system according to claim 9, wherein
the memory system
writes the copying data the second block for each constituent data that has a size smaller than the first block,
after the writing first constituent data into the second block, verifies the first constituent data written into the second block,
writes second constituent data subsequent to the first constituent data into a physical address subsequent to a physical address which is a writing destination of the first constituent data when a verification result is good, and
changes a writing destination of the first constituent data within the same second block when the verification result is not good.

13. The memory system according to claim 9, further comprising:
a loading unit that reads an address management table that is migrated into the other first block during power-on and writes the read address management table into the second memory, wherein
when the address management table migrated into the other first block is destroyed, the loading unit reads copying data written into the second block and writes the read copying data into the second memory.

14. The memory system according to claim 10, further comprising:
a loading unit that reads an address management table that is migrated into the other first block during power-on and writes the read address management table into the second memory, wherein
when the address management table migrated into the other first block is destroyed, the loading unit reads copying data written into the second block and writes the read copying data into the second memory.

15. The memory system according to claim 11, further comprising:
a loading unit that reads an address management table that is migrated into the other first block during power-on and writes the read address management table into the second memory, wherein
when the address management table migrated into the other first block is destroyed, the loading unit reads copying data written into the second block and writes the read copying data into the second memory.

16. The memory system according to claim 12, further comprising:
a loading unit that reads an address management table that is migrated into the other first block during power-on and writes the read address management table into the second memory, wherein
when the address management table migrated into the other first block is destroyed, the loading unit reads copying data written into the second block and writes the read copying data into the second memory.

17. The memory system according to claim 9, further comprising:
a loading unit that reads an address management table that is migrated into the other first block during power-on and writes the read address management table into the second memory, wherein
the migrating unit writes a plurality of items of copying data into the second block,
when the address management table migrated into the other first block is destroyed, the loading unit verifies partial data corresponding to the destroyed portion included in the copying data for each item of copying data that is written into the second block, and
when a verification result of the partial data is good, the loading unit writes the partial data of which the verification result is good into the second memory as a substitute for the destroyed portion.

18. The memory system according to claim 9, wherein
the predetermined point in time is the time of power-off.
